(19) United States
(12) Patent Application Publication
(10) Pub. No.: US 2004/0253040 A1
(43) Pub. Date: Dec. 16, 2004

(54) Squeezable container with a rigid section

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/870,371

(22) Filed: Jun. 16, 2004

Related U.S. Application Data
(63) Continuation-in-part of application No. 10/420,271, filed on Apr. 22, 2003, now Pat. No. 6,779,938.

(51) Int. Cl. B67D 5/56

(52) U.S. Cl. 401/132

(57) ABSTRACT

A small slender sealed container that may be used to store small quantity of substance, such as medications, in a sealed environment and easily and sanitarily dispenses the fluid for application as desired. The squeezable container with a rigid section comprises of a small slender container with a first end and a second end with a compressible sealed compartment near the first end and an opening means at a rigid section for access to the contents in the compressible sealed compartment between the first and second ends of the slender container. When the compressible sealed compartment near the first end is opened through the opening means, it is separated from the second end. The contents of the previously sealed compartment may then be applied to the desired location.

This application is a continuation-in-part of the prior nonprovisional U.S. patent application No. 10/420,271, filed on Apr. 22, 2003, entitled Container with Applicator.

### BACKGROUND

1. Field of Invention

The present invention relates to a small sealed container. More specifically, the present invention relates to a small slender sealed container with a compressible section and a rigid section.

2. Description of Related Art

Small containers in the general form of an elongated tube are generally used to e and/or apply small quantities of products such as perfume, alcohol, and medications. The small container's contents are generally not exhausted with just one use. Therefore, the container must be re-closable or else the remaining contents must be disposed of.

With the existing designs, the containers are generally designed for multiple uses and, if contamination is a concern, a disposable applicator is required. Furthermore, the existing designs are generally bulkier and cost more to manufacture than the invention disclosed due to their unnecessarily large capacity and the multiple applicators required for multiple access to the content if contamination of the content is a concern. The existing designs are also more difficult to transport and store compactly.

### SUMMARY OF THE INVENTION

The present invention is a small slender sealed container that may be used to store small quantity of substance, such as medications, in a sealed environment and easily and sanitarily dispenses the fluid for application as desired. The content of the slender container is completely sealed and will not leak or evaporate from the container and cannot be contaminated. The squeezable container with a rigid section comprises of a small slender container with a first end and a second end with a compressible sealed compartment near the first end and an opening means at a rigid section for access to the contents in the compressible sealed compartment between the first and second ends of the slender container. When the compressible sealed compartment near the first end is opened through the opening means, it is separated from the second end. After application, the previously sealed compartment is disposed of.

### DESCRIPTION OF THE DRAWINGS

FIG. 1 shows the preferred embodiment of the squeezable container with a rigid section.

FIG. 2 shows another embodiment of the squeezable container with a rigid section.

FIG. 3 shows another embodiment of the squeezable container with a rigid section.

FIG. 4 shows another embodiment of the squeezable container with a rigid section.

FIG. 5 shows another embodiment of the squeezable container with a rigid section.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

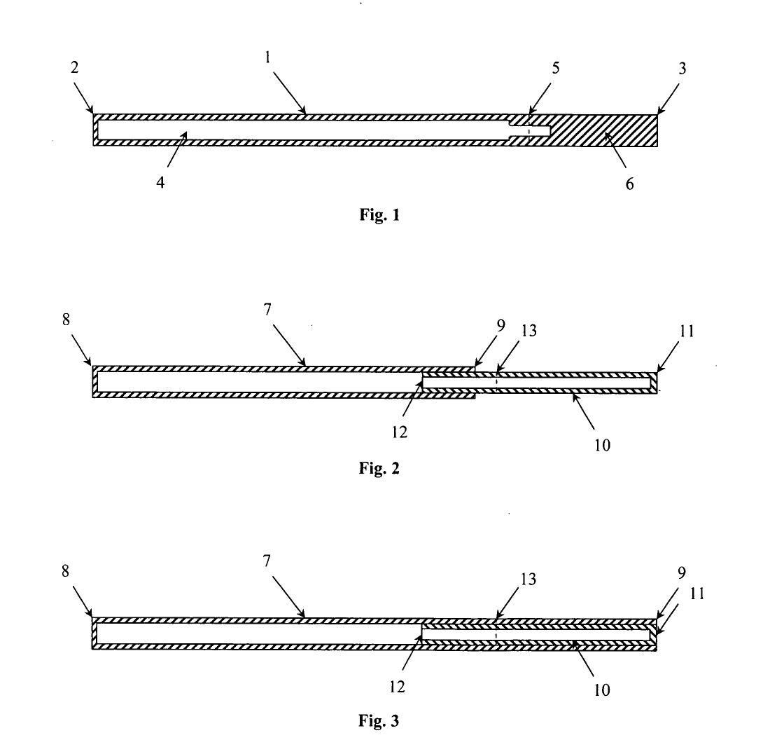

FIG. 1 shows the preferred embodiment of the squeezable container with a rigid section. The preferred embodiment of the squeezable container with a rigid section comprises an elongated plastic housing I with a first end 2 and a second end 3. In the preferred embodiment, the elongated plastic housing I has a generally constant outside diameter. A compressible sealed compartment 4 is located near the first end 2 with an opening means 5 in the form of a score line disposed at a rigid section 6 between the first end 2 and the second end 3 of the elongated housing 1. The section of the elongated plastic housing I at the compressible sealed compartment 4 has a thinner wall thickness which allows compression of the sealed compartment 4. The section of the elongated plastic housing I at the rigid section 6 is generally solid or has a much thicker wall thickness to resist bending and compression and allows the opening means 5 such as a score line to be snapped open upon bending. The squeezable container with a rigid section may be used to store a small amount of substance such as a liquid, a viscous substance, or a powder in the compressible sealed compartment 4. The substance is extracted from the compressible sealed compartment 4 by opening the compressible sealed compartment 4 through the opening means 5 and separating the previously sealed compartment 4 from the second end 3 thereby allowing extraction of the contents in the sealed compartment 4 by squeezing the compressible sealed compartment 4.

FIG. 2 shows another embodiment of the squeezable container with a rigid section. In this embodiment, the squeezable container with a rigid section comprises a compressible elongated housing 7 with a first sealed end 8 and a second open end 9. A rigid elongated section 10 with a sealed end II and an open end 12 is inserted with its open end 12 into and affixed to said second open end 9 of said compressible elongated housing 7 sealing the compressible elongated housing 7. An opening means 13 such as a score line is formed at the rigid elongated section 10 outside of the compressible elongated housing 7 to allow snapping open of the rigid elongated section 10 when it is bent. The compressible elongated housing 7 may be used to store small amount of substance and dispense it by snapping open the rigid elongated section 10 through the opening means 13 and separating the now opened compressible elongated housing 7 from the fractured rigid elongated section 10 thereby allowing extraction of the contents in the compressible elongated housing 7 by squeezing the compressible elongated housing 7.

FIG. 3 shows another embodiment of the squeezable container with a rigid section. In this embodiment, the squeezable container with a rigid section comprises a compressible elongated housing 7 with a first sealed end 8 and a second open end 9. A rigid elongated section 10 with a sealed end 11 and an open end 12 is inserted with its open end 12 into and affixed to said second open end 9 of said compressible elongated housing 7 sealing the compressible elongated housing 7. An opening means 13 such as a score line is formed through the compressible elongated housing 7 and at the rigid elongated section 10 inside of the compressible elongated housing 7 to allow snapping open of the rigid elongated section 10 when it is bent. The compressible elongated housing 7 may be used to store small amount of substance and dispense it by snapping open the rigid elongated section 10 through the opening means 13 and separating the now opened compressible elongated housing 7 from the fractured rigid elongated section 10 thereby allowing extraction of the contents in the compressible elongated housing 7 by squeezing the compressible elongated housing 7.

FIG. 4 shows the squeezable container with a rigid section shown in FIG. 2 enclosing an applicator 14. In this embodiment, the squeezable container with a rigid section comprises a compressible elongated housing 7 with a first sealed end 8 and a second open end 9. A rigid elongated section 10 with a sealed end 11 and an open end 12 is inserted with its open end 12 into and affixed to said second open end 9 of said compressible elongated housing 7 sealing the compressible elongated housing 7. An opening means 13 such as a score line is formed at the rigid elongated section 10 outside of the compressible elongated housing 7 to allow snapping open of the rigid elongated section 10 when it is bent. An applicator 14 such as a brush, cotton swab, or foam tip is affixed to the sealed end 11 of the rigid elongated section 10 and disposed within the rigid elongated section 10 and the compressible elongated housing 7. The compressible elongated housing 7 may be used to store small amount of substance and dispense it by snapping open the rigid elongated section 10 through the opening means 13 and separating the now opened compressible elongated housing 7 from the fractured rigid elongated section 10 thereby allowing extraction of the contents in the compressible elongated housing 7 by squeezing the compressible elongated housing 7. After separation of the compressible elongated housing 7 and the fractured rigid elongated section 10, the applicator 14 may be used to apply the contents in the compressible elongated housing 7.

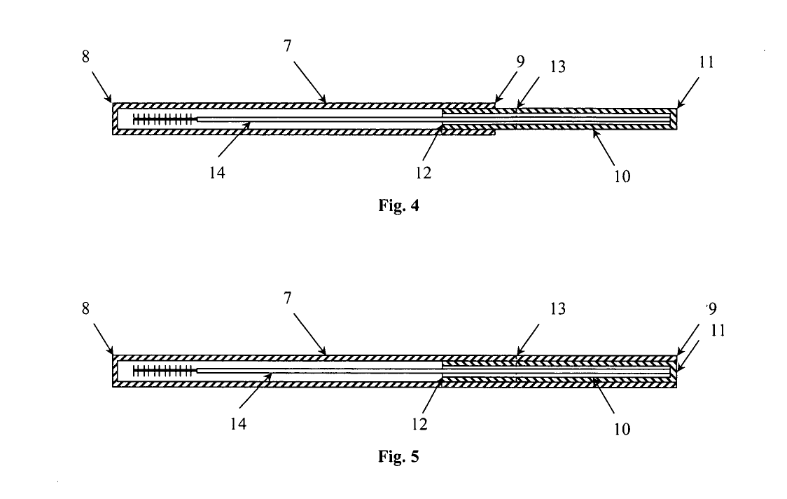

FIG. 5 shows the squeezable container with a rigid section shown in FIG. 3 enclosing an applicator 14. In this embodiment, the squeezable container with a rigid section comprises a compressible elongated housing 7 with a first sealed end 8 and a second open end 9. A rigid elongated section 10 with a sealed end 11 and an open end 12 is inserted with its open end 12 into and affixed to said second open end 9 of said compressible elongated housing 7 sealing the compressible elongated housing 7. An opening means 13 such as a score line is formed through the compressible elongated housing 7 and at the rigid elongated section 10 inside of the compressible elongated housing 7 to allow snapping open of the rigid elongated section 10 when it is bent. An applicator 14 such as a brush, cotton swab, or foam tip is affixed to the sealed end 11 of the rigid elongated section 10 and disposed within the rigid elongated section 10 and the compressible elongated housing 7. The compressible elongated housing 7 may be used to store small amount of substance and dispense it by snapping open the rigid elongated section 10 through the opening means 13 and separating the now opened compressible elongated housing 7 from the fractured rigid elongated section 10 thereby allowing extraction of the contents in the compressible elongated housing 7 by squeezing the compressible elongated housing 7. After separation of the compressible elongated housing 7 and the fractured rigid elongated section 10, the applicator 14 may be used to apply the contents in the compressible elongated housing 7.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A squeezable container with a rigid section comprising an elongated housing with a first end and a second end with a compressible sealed compartment near the first end with an opening means at a rigid section between the first end and the second end wherein the elongated housing may be used to store and dispense small amount of a substance by opening the sealed compartment through the opening means at the rigid section and separating the now opened sealed compartment from the second end thereby allowing extraction of the contents in the sealed compartment by squeezing the previously sealed compartment.

2. A squeezable container with a rigid section as in claim 1, wherein the opening means is a scoring that can be snapped open to release the substance in the sealed compartment.

3. A squeezable container with a rigid section as in claim 1, wherein the substance is a liquid.

4. A squeezable container with a rigid section as in claim 1, wherein the substance is a viscous substance.

5. A squeezable container with a rigid section as in claim 1, wherein the substance is a powder.

6. A squeezable container with a rigid section comprising an elongated housing with generally a constant diameter throughout its length with a first end and a second end with a compressible sealed compartment near the first end with an opening means at a rigid section between the first end and the second end wherein the elongated housing may be used to store and dispense small amount of a substance by opening the sealed compartment through the opening means at the rigid section and separating the now opened sealed compartment from the second end thereby allowing extraction of the contents in the sealed compartment by squeezing the previously sealed compartment.

7. A squeezable container with a rigid section as in claim 6, wherein the opening means is a scoring that can be snapped open to release the substance in the sealed compartment.

8. A squeezable container with a rigid section as in claim 6, wherein the substance is a liquid.

9. A squeezable container with a rigid section as in claim 6, wherein the substance is a viscous substance.

10. A squeezable container with a rigid section as in claim 6, wherein the substance is a powder.

11. A squeezable container with a rigid section comprising a compressible elongated housing with a first sealed end and a second open end with a rigid elongated section with an opening means at said rigid elongated section and with a sealed on one side of said opening means and an open end on the other side of said opening means affixed to said second open end of said compressible elongated housing and wherein the compressible elongated housing may be used to store and dispense small amount of a substance by opening the rigid elongated section through the opening means and separating the now opened compressible elongated housing from the severed rigid elongated section thereby allowing extraction of the contents in the compressible elongated housing by squeezing the compressible elongated housing.

12. A squeezable container with a rigid section as in claim 11, wherein the opening means is a scoring that can be snapped open to release the substance in the compressible elongated housing.

13. A squeezable container with a rigid section as in claim 11, wherein the substance is a liquid.

14. A squeezable container with a rigid section as in claim 11, wherein the substance is a viscous substance.

15. A squeezable container with a rigid section as in claim 11, wherein the substance is a powder.

16. A squeezable container with a rigid section as in claim 11, wherein an applicator is affixed to said seal end of said rigid elongated section and disposed within the rigid elongated section and the compressible elongated housing.

17. A squeezable container with a rigid section as in claim 12, wherein an applicator is affixed to said seal end of said rigid elongated section and disposed within the rigid elongated section and the compressible elongated housing.
